(19) United States
(12) Patent Application Publication
(10) Pub. No.: US 2018/0335918 A1
(43) Pub. Date: Nov. 22, 2018

(54) TOUCH SUBSTRATE, TOUCH DISPLAY APPARATUS HAVING THE SAME, AND FABRICATING METHOD

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Qingpu Wang, Beijing (CN); Lei Zhang, Beijing (CN); Gaoliang Shi, Beijing (CN); Jinxi Wu, Beijing (CN)

(73) Assignees: BOE TECHNOLOGY GROUP CO., LTD., Beijing (CN); HEFEI XINSHENG OPTOELECTRONICS TECHNOLOGY CO., LTD ., Hefei (CN)

(21) Appl. No.: 15/531,129

(22) PCT Filed: Dec. 12, 2016
(86) PCT No.: PCT/CN2016/109485

§ 371 Date: May 26, 2017

(30) Foreign Application Priority Data
Jul. 11, 2016 (CN) 201610541148.5

(51) Int. Cl. G06F 3/0488

(52) U.S. Cl. CPC G06F 3/0488

(57) ABSTRACT

The present application discloses a touch substrate having a touch electrode area and a peripheral area. The touch substrate includes a base substrate; a first touch electrode layer on the base substrate including a plurality of first touch electrodes in the touch electrode area; a plurality of first touch electrode signal lines in the peripheral area coupled to the plurality of first touch electrodes respectively; and a first ground line in the peripheral area provided with a ground voltage, configured to discharge electrostatic charge in the touch substrate. A projection of the first ground line on the base substrate overlaps with those of the plurality of first touch electrode signal lines. The first ground line is insulated from the plurality of first touch electrode signal lines.

### CROSS-REFERENCE TO RELATED APPLICATION

This application claims priority to Chinese Patent Application No. 201610541148.5, filed Jul. 11, 2016, the contents of which are incorporated by reference in the entirety.

### TECHNICAL FIELD

The present invention relates to display technology, more particularly, to a touch substrate, a touch display apparatus having the same, and a fabricating method.

### BACKGROUND

In recent years, touch apparatuses have been widely used in many electronic devices such as mobile phones, computer display panels, touch screens, satellite navigation devices, digital cameras, etc. Examples of touch apparatuses include a mutual capacitive touch control device and a self-capacitive touch control device. In a mutual capacitive touch control device, the touch electrode can be a touch driving electrode (Tx), whereas the touch sensing electrode (Rx) can be disposed on the color filter substrate. In a self-capacitive touch control device, the touch electrode can achieve touch control function alone.

When a finger of a user performs touch control functions on a touch panel, electrostatic charges accumulate on the touch panel. When the electrostatic charges are transmitted to the touch electrode, the touch control functions may be affected.

### SUMMARY

In one aspect, the present invention provides a touch substrate having a touch electrode area and a peripheral area, comprising a base substrate; a first touch electrode layer on the base substrate comprising a plurality of first touch electrodes in the touch electrode area; a plurality of first touch electrode signal lines in the peripheral area coupled to the plurality of first touch electrodes respectively; and a first ground line in the peripheral area provided with a ground voltage, configured to discharge electrostatic charge in the touch substrate; wherein a projection of the first ground line on the base substrate overlaps with those of the plurality of first touch electrode signal lines; the first ground line is insulated from the plurality of first touch electrode signal lines.

Optionally, the first ground line crosses over the plurality of first touch electrode signal lines.

Optionally, at least one of the plurality of first touch electrode signal lines comprise a first portion, a second portion, and a third portion connecting the first portion and the second portion; the first portion being configured to be connected to a touch control integrated circuit; the second portion being configured to be connected to a first touch electrode; the first portion extends substantially along a first direction; the third portion extends substantially along a second direction; the plurality of first touch electrodes are arranged along the second direction; and a portion of the first ground line is on a side of the third portion proximal to the plurality of first touch electrodes and crosses over the second portion; the portion of the first ground line extending substantially along the second direction.

Optionally, the first ground line is a single line encircling first portions and third portions of the at least one of the plurality of first touch electrode signal lines and crossing over second portions of the at least one of the plurality of first touch electrode signal lines; an area encircled by the first ground line is in the peripheral area and outside the touch electrode area.

Optionally, the first ground line comprises a non-crossing-over portion in a first layer and a crossing-over portion in a second layer different from the first layer; a projection of the crossing-over portion on the base substrate overlaps with that of one of the plurality of first touch electrode signal lines; and a projection of the non-crossing-over portion on the base substrate is outside that of any first touch electrode signal line.

Optionally, the first layer comprises the non-crossing-over portion of the first ground line and the plurality of first touch electrode signal lines.

Optionally, the second layer comprises the crossing-over portion of the first ground line and the plurality of first touch electrodes.

Optionally, the non-crossing-over portion of the first ground line is made of a metal material, and the crossing-over portion is made of a non-metal transparent electrode material.

Optionally, the first layer comprises the non-crossing-over portion and the plurality of first touch electrode signal lines; the first layer is made of a metal material; the second layer comprises the crossing-over portion and the plurality of first touch electrodes; and the second layer is made of a non-metal transparent electrode material.

Optionally, the touch substrate further comprises an insulating layer between the first layer and the second layer; a first via and a second via extending through the insulating layer, the non-crossing-over portion electrically connected to two ends of the crossing-over portion through the first via and the second via, respectively.

Optionally, the plurality of first touch electrodes are a plurality of touch sensing electrodes, and the plurality of first touch electrode signal lines are a plurality of touch sensing signal lines.

Optionally, the touch substrate further comprises a second touch electrode layer on the base substrate comprising a plurality of second touch electrodes in the touch electrode area; a plurality of second touch electrode signal lines in the peripheral area coupled to the plurality of second touch electrodes respectively; and a second ground line in the peripheral area provided with a ground voltage, configured to discharge electrostatic charge in the touch substrate; wherein the second ground line encircles the touch electrode area and the peripheral area.

Optionally, the plurality of first touch electrodes are a plurality of touch sensing electrodes, the plurality of first touch electrode signal lines are a plurality of touch sensing signal lines; and the plurality of second touch electrodes are a plurality of touch driving electrodes, the plurality of second touch electrode signal lines are a plurality of touch driving signal lines.

Optionally, a total number of the plurality of second touch electrode signal lines is greater than a total number of the plurality of first touch electrode signal lines.

Optionally, the plurality of first touch electrode signal lines, the plurality of second touch electrode signal lines, and the second ground line are in a same layer.

Optionally, the plurality of first touch electrode signal lines, the plurality of second touch electrode signal lines, and the second ground line are made of a metal material.

In another aspect, the present invention provides a method of fabricating a touch substrate having a touch electrode area and a peripheral area, comprising forming a first touch electrode layer on the base substrate comprising a plurality of first touch electrodes in the touch electrode area; forming a plurality of first touch electrode signal lines in the peripheral area coupled to the plurality of first touch electrodes respectively; and forming a first ground line in the peripheral area provided with a ground voltage, configured to discharge electrostatic charge in the touch substrate; wherein the first ground line is formed so that a projection of the first ground line on the base substrate overlaps with those of the plurality of first touch electrode signal lines; the first ground line is insulated from the plurality of first touch electrode signal lines.

Optionally, forming the first ground line comprises forming a first layer comprising a non-crossing-over portion of the first ground line; and forming a second layer comprising a crossing-over portion of the first ground line; the second layer being different from the first layer; wherein the non-crossing-over portion is formed so that a projection of the non-crossing-over portion on the base substrate is outside that of any first touch electrode signal line; and the crossing-over portion is formed so that a projection of the crossing-over portion on the base substrate overlaps with that of a first touch electrode signal line.

Optionally, the method comprising forming the first layer comprising the non-crossing-over portion and the plurality of first touch electrode signal lines on the base substrate; forming an insulating layer on a side of the first layer distal to the base substrate; forming a first via and a second via extending through the insulating layer; and forming the second layer comprising the crossing-over portion and the plurality of first touch electrodes on a side of the insulating layer distal to the first layer; wherein the non-crossing-over portion electrically connected to two ends of the crossing-over portion through the first via and the second via, respectively.

Optionally, forming the first layer comprises forming the first layer comprising the non-crossing-over portion, the plurality of first touch electrode signal lines, a plurality of second touch electrode signal lines, and a second ground line in the peripheral area; forming the second layer comprises forming the second layer comprising the crossing-over portion in the peripheral area, and the plurality of first touch electrodes and a plurality of second touch electrodes in the touch electrode area; the plurality of second touch electrode signal lines in the peripheral area coupled to the plurality of second touch electrodes respectively; and the second ground line encircles the touch electrode area.

In another aspect, the present invention provides a touch display apparatus comprising a touch substrate described herein or fabricated by a method described herein.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the layout of a ground line in a conventional touch panel.

FIG. 2 is a cross-sectional view along the A-A′ direction of the touch panel in FIG. 1.

FIG. 3 illustrates occurrence of electrostatic discharge in a black matrix layer in a conventional touch panel.

FIG. 4 is a diagram illustrating the layout of a ground line in a touch substrate in some embodiments according to the present disclosure.

FIG. 5 is a diagram illustrating the layout of a ground line and the first touch electrode signal lines in a touch substrate in some embodiments according to the present disclosure.

FIG. 6 is a diagram illustrating the layout of a ground line and the first touch electrode signal lines in a touch substrate in some embodiments according to the present disclosure.

FIG. 7 is a cross-sectional view along the B-B′ direction of the touch substrate in FIG. 4.

FIG. 8 illustrates discharge of electrostatic charge in a black matrix layer in a touch substrate in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Fabrication of conventional touch panels typically involves five lithographic processes. A black matrix layer is formed on a base substrate in the first process. An indium tin oxide electrode bridge layer is formed on the black matrix layer in the second process. On a side of the indium tin oxide electrode bridge layer, an insulating resin layer is formed in the third process. Subsequently, an indium tin oxide touch electrode layer is formed on a side of the insulating resin layer distal to the black matrix layer, a projection of the indium tin oxide touch electrode layer partially overlapping with the black matrix layer. In the fifth process, a touch electrode signal line layer is formed in a peripheral area of the touch panel. Lastly, a protection resin layer is formed on a side of the touch electrode signal line layer distal to the black matrix layer.

Because a projection of the black matrix layer partially overlaps with a projection of the touch electrode layer, the black matrix layer in the overlapping region is prone to electrostatic breakdown, resulting in defects in the touch panel. When electrostatic charges (e.g., from a human body or a display apparatus) accumulate on the touch electrodes in the overlapping region, a very large discharge current occurs between adjacent touch electrodes in a very short period of time. The discharge current breaks down the black matrix layer between the adjacent touch electrodes, resulting in open or short between the adjacent touch electrodes. The damages may result in deteriorated performance of the touch panel, sometimes permanent defects. The issue becomes particularly severe for the touch sensing electrodes. Because the signals conducted by the touch sensing electrodes are relatively small, even a minor breakdown in the black matrix layer can results in touch electrode dysfunction.

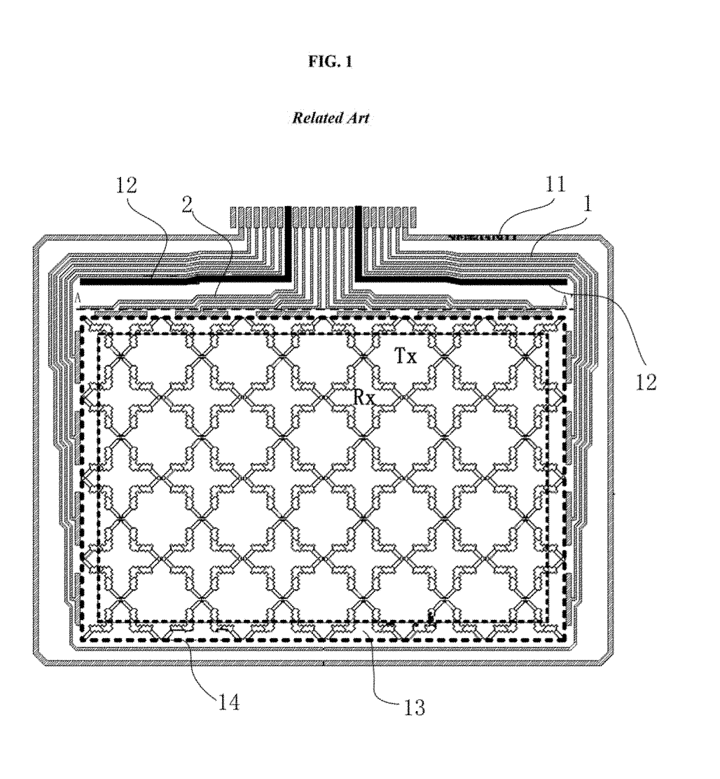

FIG. 1 is a diagram illustrating the layout of a ground line in a conventional touch panel. Referring to FIG. 1, the conventional touch panel includes three ground lines. The first ground line 11 encircles the touch panel, discharging electrostatic charges surrounding the edges of the touch panel to ground. Between the touch driving signal lines 1 and the touch sensing signal lines 2, the touch panel includes two other ground lines 12. The ground lines 12 are separated from each other, and extend through only a limited area in the black matrix area. Thus, the ground lines 12 have limited ability to divert the electrostatic charges in the touch panel to ground. When the electrostatic charges in the touch panel accumulate to a certain level, the black matrix layer in an area 13 overlapping with the touch electrode 14 is prone to electrostatic breakdown, resulting in a short between adjacent touch electrodes.

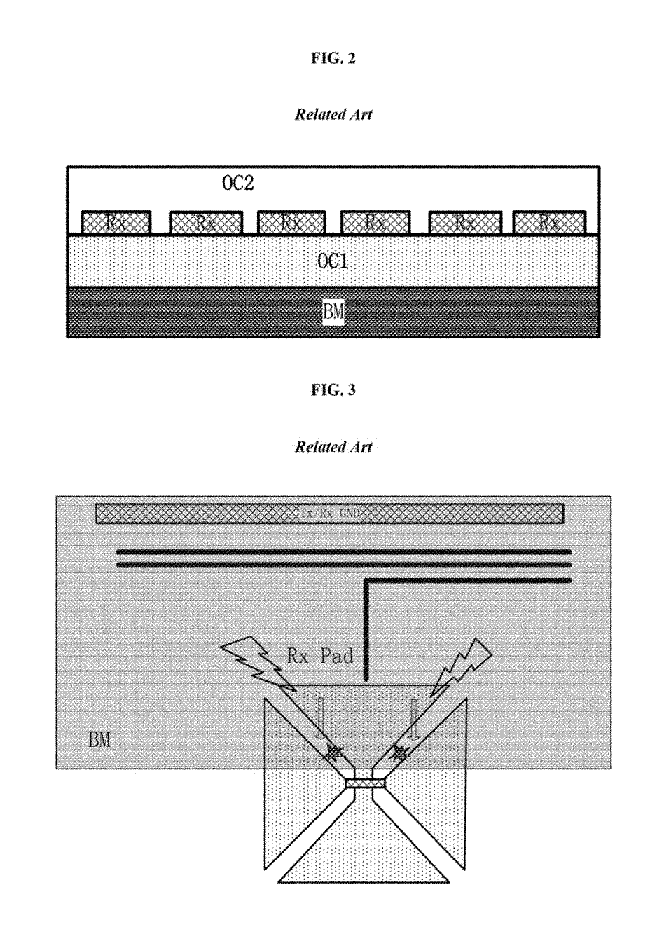

FIG. 2 is a cross-sectional view along the A-A′ direction of the touch panel in FIG. 1. Referring to FIG. 2, the cross-section is along an interface between the touch sensing signal lines. The interface is in an overlapping region where a projection of the black matrix layer on a base substrate overlaps with a projection of the touch electrode, which is prone to electrostatic breakdown. As shown in FIG. 2, the ground line 12 (any ground line) is absent in this area. As shown in FIG. 1, the ground line 12 is distant from the interface region and the overlapping region 13.

FIG. 3 illustrates occurrence of electrostatic discharge in a black matrix layer in a conventional touch panel. Referring to FIG. 3, the electrostatic charges are prone to accumulate in the overlapping region. However, the ground line is absent in this area, the electrostatic charges cannot be easily diverted to ground. When the electrostatic charges accumulate to a certain level, electrostatic breakdown in the black matrix layer BM occurs, resulting in defects in the touch panel.

Accordingly, the present invention provides, inter alia, a touch substrate, a touch display apparatus having the same, and a fabricating method that substantially obviate one or more of the problems due to limitations and disadvantages of the related art. In one aspect, the present disclosure provides a touch substrate having a touch electrode area and a peripheral area. In some embodiments, the touch substrate includes a base substrate; a first touch electrode layer on the base substrate having a plurality of first touch electrodes in the touch electrode area; a plurality of first touch electrode signal lines in the peripheral area coupled to the plurality of first touch electrodes respectively; and a first ground line in the peripheral area provided with a ground voltage, configured to discharge electrostatic charge in the touch substrate. Optionally, a projection of the first ground line on the base substrate overlaps with those of the plurality of first touch electrode signal lines, the first ground line being insulated from the plurality of first touch electrode signal lines. Optionally, the first ground line crosses over the plurality of first touch electrode signal lines. Optionally, the first ground line is a single line encircling the plurality of first touch electrode signal lines and crossing over a plurality of first touch electrode signal lines, the area encircled by the first ground line is in the peripheral area and is, however, outside the touch electrode area. Optionally, the touch substrate further includes a black matrix layer in a black matrix area, the black matrix area partially overlapping with the touch electrode area, forming an overlapping region. Optionally, at least a portion of the first ground line is proximal to the overlapping region. Optionally, the first ground line crosses over the plurality of first touch electrode lines in an area proximal to the overlapping region.

In some embodiments, at least one (e.g., at least some, at least multiple ones, or all) of the plurality of first touch electrode signal lines includes a first portion, a second portion, and a third portion connecting the first portion and the second portion; the first portion being configured to be connected to a touch control integrated circuit; the second portion being configured to be connected to a first touch electrode. The first portion extends substantially along a first direction (e.g., a column direction), the third portion extends substantially along a second direction (e.g., a row direction), and the plurality of first touch electrodes are arranged along the second direction (e.g., the row direction). A portion of the first ground line is on a side of the third portion proximal to the plurality of first touch electrodes and crosses over the second portion; the portion of the first ground line extending substantially along the second direction.

In some embodiments, the touch substrate further includes a second touch electrode layer on the base substrate having a plurality of second touch electrodes in the touch electrode area, a plurality of second touch electrode signal lines in the peripheral area coupled to the plurality of second touch electrodes respectively, and a second ground line in the peripheral area provided with a ground voltage, configured to discharge electrostatic charge in the touch substrate. The second ground line encircles the touch electrode area and the peripheral area.

Optionally, the plurality of first touch electrodes are a plurality of touch sensing electrodes, the plurality of first touch electrode signal lines are a plurality of touch sensing signal lines, the plurality of second touch electrodes are a plurality of touch driving electrodes, and the plurality of second touch electrode signal lines are a plurality of touch driving signal lines. Optionally, the plurality of first touch electrodes are a plurality of touch driving electrodes, the plurality of first touch electrode signal lines are a plurality of touch driving signal lines, the plurality of second touch electrodes are a plurality of touch sensing electrodes, and the plurality of second touch electrode signal lines are a plurality of touch sensing signal lines.

As used herein the term “peripheral area” refers to an area where various circuits and wires are provided to transmit signals to the display substrate. To increase the transparency of the display apparatus, non-transparent or opaque components of the display apparatus (e.g., battery, printed circuit board, metal frame), can be disposed in the peripheral area rather than in the display areas.

As used herein the term “touch electrode area” refers an area of a touch substrate that includes a touch electrode layer, e.g., the touch electrode area is defined by the touch electrode layer. Optionally, a touch electrode layer includes touch electrodes (e.g., touch sensing electrodes and touch driving electrodes) and dummy electrodes. Optionally, the touch electrode area includes a plurality of touch electrodes and a plurality of dummy electrodes.

As used herein the term “black matrix area” refers to an area of a touch substrate that includes a peripheral black matrix layer, e.g., the black matrix area is defined by the peripheral black matrix layer. Optionally, the black matrix area partially overlaps with the touch electrode area. Optionally, the black matrix area is outside the touch electrode area.

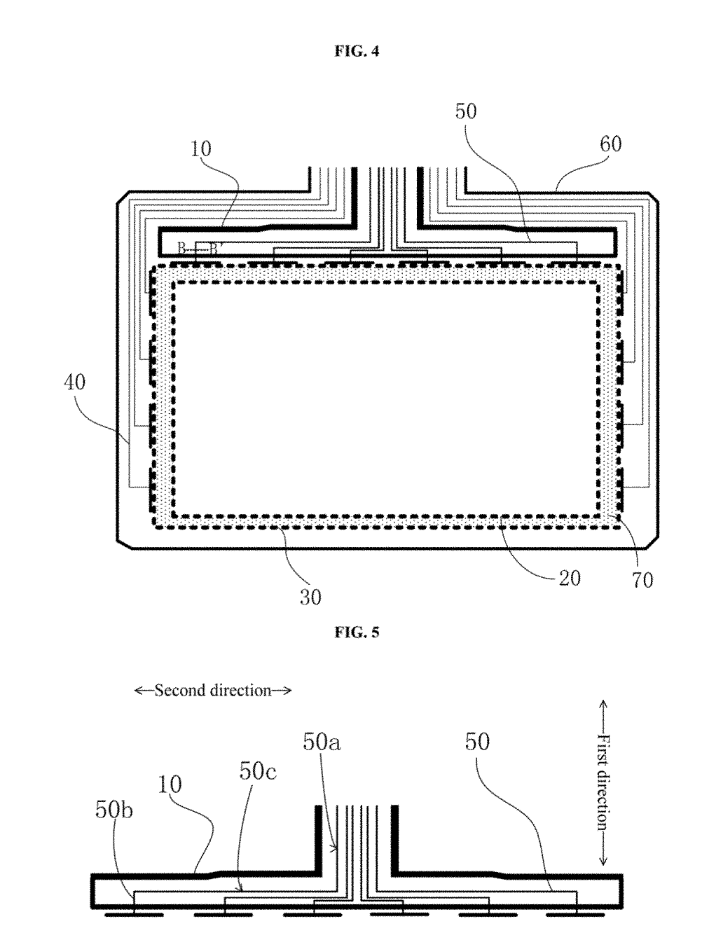

FIG. 4 is a diagram illustrating the layout of a ground line in a touch substrate in some embodiments according to the present disclosure. Referring to FIG. 4, the touch substrate in some embodiments includes a touch electrode area and a peripheral area abutting each other, the border between the touch electrode area and the peripheral area is indicated as 30 in FIG. 4. The area encircled by the border 30 is the touch electrode area, and the area outside the border 30 is the peripheral area. Various signal lines such as a plurality of first electrode signal lines 50 (e.g., touch sensing signal lines), a plurality of second touch electrode signal lines 40 (e.g., touch driving signal lines), a first ground line 10, and a second ground line 60, are disposed in the peripheral area. The touch substrate in FIG. 4 further includes a black matrix layer in a black matrix area, the border of which is indicated as 20 in FIG. 4. The black matrix layer is outside the area encircled by the border 20. The touch electrode area and the black matrix layer in FIG. 4 partially overlapping with each other, forming an overlapping region 70 (the dotted area in FIG. 4).

The first ground line 10 and the second ground line 60 are configured to divert electrostatic charge in the touch substrate to ground. The touch substrate includes a base substrate and a first touch electrode layer on the base substrate having a plurality of first touch electrodes in the touch electrode area (not explicitly shown in FIG. 4; see, e.g., FIG. 1). The plurality of first touch electrode signal lines 50 in the peripheral area are coupled to the plurality of first touch electrodes respectively. As shown in FIG. 4, a projection of the first ground line 10 on the touch substrate overlaps with those of the plurality of first touch electrode signal lines 50. The first ground line 10 in the peripheral area is provided with a ground voltage (e.g., electrically connected to a ground voltage terminal in a touch control integrated circuit). Thus, the first ground line 10 is configured to discharge electrostatic charge in the touch substrate.

Specifically, the first ground line 10 in FIG. 4 crosses over the plurality of first touch electrode signal lines 50. The first ground line 10 is a single line encircling the plurality of first touch electrode signal lines 50, and crosses over the plurality of first touch electrode signal lines 50. The first ground line 10 has two terminals configured to be connected with a touch control integrated circuit. Optionally, the first ground line 10 includes two separated lines, but still crosses over the plurality of first touch electrode signal lines 50. For example, each separated line of the first ground line 10 has a terminal configured to be connected with a touch control integrated circuit, and extends over the peripheral area to cross over the plurality of first touch electrode signal lines 50. In some embodiments, the touch substrate further includes a black matrix layer in a black matrix area, the black matrix area partially overlapping with the touch electrode area forming an overlapping region 70. Optionally, at least a portion of the first ground line 10 is proximal to the overlapping region 70. The first ground line 10 crosses over the plurality of first touch electrode signal lines 50 in an area proximal to the overlapping region 70.

FIG. 5 is a diagram illustrating the layout of a ground line and the first touch electrode signal lines in a touch substrate in some embodiments according to the present disclosure. Referring to FIG. 5, each of the plurality of first touch electrode signal lines 50 includes a first portion 50a configured to be connected to a touch control integrated circuit, a second portion 50b configured to the connected to a first touch electrode, and a third portion 50c connecting the first portion 50a and the second portion 50b. The first portion 50a extends substantially along a first direction, the third portion 50c extends substantially along a second direction, the plurality of first touch electrodes are arranged along the second direction, a portion of the first ground line 10 is on a side of the third portion 50c proximal to the plurality of first touch electrodes and crosses over the second portion 50b; and the portion of the first ground line 10 extending substantially along the second direction. Specifically, the first portion 50a extends along a direction toward the touch substrate (the first direction), the first ground line 10 then bends towards two sides of the touch substrate, the third portion 50c extends along a direction substantially parallel to the edge of the touch substrate (the second direction) until to a position corresponding to a first touch electrode, then the first ground line 10 bends towards the edge of the touch substrate, and the second portion 50b extends towards the corresponding first touch electrode substantially along the first direction.

As used herein, the term “substantially parallel” means that an angle is in the range of 0) degree to approximately 45 degrees, e.g., 0 degree to approximately 5 degrees, 0 degree to approximately 10 degrees, 0 degree to approximately 15 degrees, 0 degree to approximately 20 degrees, 0 degree to approximately 25 degrees, 0 degree to approximately 30 degrees. As used herein, the term “substantially perpendicular” means that an angle is in the range of approximately 45 degrees to approximately 135 degrees, e.g., approximately 85 degrees to approximately 95 degrees, approximately 80 degrees to approximately 100 degrees, approximately 75 degrees to approximately 105 degrees, approximately 70 degrees to approximately 110 degrees, approximately 65 degrees to approximately 115 degrees, approximately 60 degrees to approximately 120 degrees.

Optionally, the first ground line 10 is a single line encircling first portions 50a and third portions 50c of the at least one (e.g., at least some, at least multiple ones, or all) of the plurality of first touch electrode signal lines 50 and crossing over second portions 50b of the at least one (e.g., at least some, at least multiple ones, or all) of the plurality of first touch electrode signal lines 50. An area encircled by the first ground line 10 is in the peripheral area and outside the touch electrode area. Optionally, the touch substrate further includes a black matrix layer in a black matrix area, the black matrix area partially overlapping with the touch electrode area, forming an overlapping region. At least a portion of the first ground line 10 is proximal to overlapping region. The first ground line 10 crosses over the second portions 50b of the at least one (e.g., at least some, at least multiple ones, or all) of the plurality of first touch electrode signal lines 50 in an area proximal to the overlapping region.

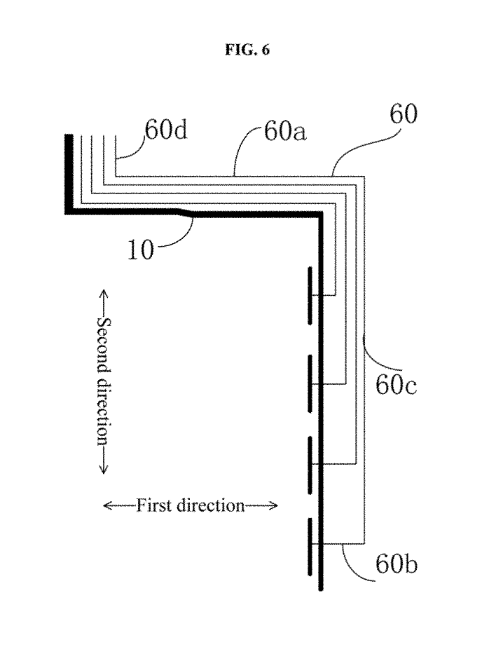

FIG. 6 is a diagram illustrating the layout of a ground line and the first touch electrode signal lines in a touch substrate in some embodiments according to the present disclosure. Referring to FIG. 6, the touch substrate includes a plurality of second touch electrode signal lines 60 in the peripheral area coupled to the plurality of second touch electrodes respectively. The first ground line 10 crosses over the plurality of second touch electrode signal lines 60, a projection of the first ground line 10 on the base substrate overlapping with those of the plurality of second touch electrode signal lines 60. Each of the plurality of second touch electrode signal lines 60 includes a first portion 60a configured to be connected to a touch control integrated circuit, a second portion 60b configured to the connected to a second touch electrode, and a third portion 60c connecting the first portion 60a and the second portion 60b. The first portion 60a extends substantially along a first direction, the third portion 60c extends substantially along a second direction, the plurality of second touch electrodes are arranged along the second direction, a portion of the first ground line 10 is on a side of the third portion 60c proximal to the plurality of second touch electrodes and crosses over the second portion 60b, and the portion of the first ground line 10 extends substantially along the second direction. Specifically, the first portion 60a extends along a direction substantially parallel to a first edge of the touch substrate (the first direction), the first ground line 10 then bends towards a direction substantially parallel to a second edge of the touch substrate (the second direction), the third portion 60c extends along a direction substantially parallel to the second edge of the touch substrate (the second direction) until to a position corresponding to a second touch electrode, then the first ground line 10 bends towards the second edge of the touch substrate, and the second portion 60b extends towards the corresponding second touch electrode substantially along the first direction.

Optionally, the touch substrate further includes a black matrix layer in a black matrix area, the black matrix area partially overlapping with the touch electrode area, forming an overlapping region. At least a portion of the first ground line 10 is proximal to overlapping region. The first ground line 10 crosses over the second portions 60b of the at least one (e.g., at least some, at least multiple ones, or all) of the plurality of second touch electrode signal lines 60 in an area proximal to the overlapping region.

In some embodiments, the touch substrate further includes a second touch electrode layer on the base substrate having a plurality of second touch electrodes in the touch electrode area, a plurality of second touch electrode signal lines in the peripheral area coupled to the plurality of second touch electrodes respectively. Optionally, the plurality of first touch electrodes are a plurality of touch sensing electrodes, the plurality of first touch electrode signal lines 50 are a plurality of touch sensing signal lines, the plurality of second touch electrodes are a plurality of touch driving electrodes, and the plurality of second touch electrode signal lines 60 are a plurality of touch driving signal lines. Optionally, the plurality of first touch electrodes are a plurality of touch driving electrodes, the plurality of first touch electrode signal lines 50 are a plurality of touch driving signal lines, the plurality of second touch electrodes are a plurality of touch sensing electrodes, and the plurality of second touch electrode signal lines 60 are a plurality of touch sensing signal lines.

By having the ground line crossing over the plurality of touch electrode signal lines (either touch sensing signal lines or touch driving signal lines), and disposed in close proximity to the overlapping region, the electrostatic charge in the present touch substrate can be effectively diverted to ground. Moreover, the total length of the ground line nearly doubles as compared to the conventional ground line, occupying an extended area in the touch substrate. Thus, the ground line in the present touch substrate can discharge the electrostatic charge more efficiently, preventing the formation of a large discharging current between adjacent touch electrodes when electrostatic charges occur on the touch electrodes in the overlapping region. Occurrences of electrostatic breakdown in the touch substrate are eliminated, reducing product defects.

Referring to FIG. 4, the touch substrate in some embodiments further includes a second ground line 60, configured to discharge electrostatic charge in the touch substrate. The second ground line 60 encircles the touch electrode area.

In some embodiments, the first touch electrode signal lines 50, the second touch electrode signal lines 40, and the second ground line 60 are in a same layer. As used herein, the term “same layer” refers to the relationship between the layers simultaneously formed in the same step. In one example, the first touch electrode signal lines 50, the second touch electrode signal lines 40, and the second ground line 60 are in a same layer when they are formed as a result of one or more steps of a same patterning process performed in a same layer of material. In another example, the first touch electrode signal lines 50, the second touch electrode signal lines 40, and the second ground line 60 can be formed in a same layer by simultaneously performing the step of forming the first touch electrode signal lines 50, the step of forming the second touch electrode signal lines 40, and the step of forming the second ground line 60. The term “same layer” does not always mean that the thickness of the layer or the height of the layer in a cross-sectional view is the same.

Optionally, the first touch electrode signal lines 50, the second touch electrode signal lines 40, and the second ground line 60 are made of a metal material.

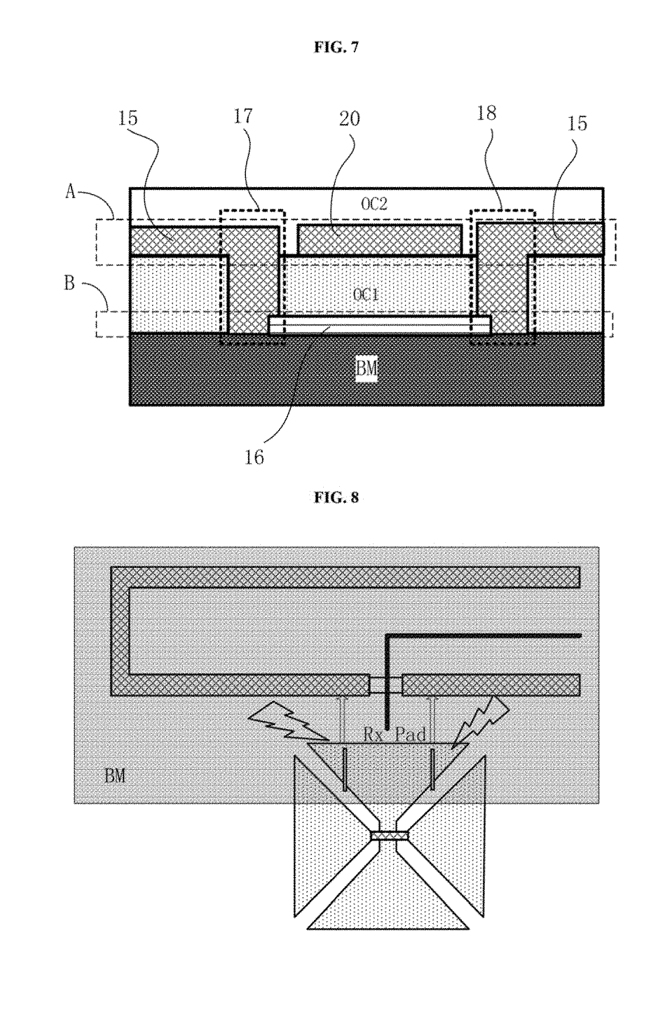

FIG. 7 is a cross-sectional view along the B-B′ direction of the touch substrate in FIG. 4. Referring to FIG. 7, the first ground line in some embodiments includes a non-crossing-over portion 15 in a first layer A and a crossing-over portion 16 in a second layer B different from the first layer A. A projection of the crossing-over portion 16 on the base substrate overlaps with that of a first touch electrode signal line 20. A projection of the non-crossing-over portion 15 on the base substrate is outside that of any first touch electrode signal line 20. Optionally, the first layer A is a metal layer. Optionally, the second layer B is an indium tin oxide layer.

In some embodiments, the first layer A includes the non-crossing-over portion 15 and the plurality of first touch electrode signal lines 20. Optionally, the first layer A includes the non-crossing-over portion 15, the first touch electrode signal lines 50, the second touch electrode signal lines 40, and the second ground line 60. Optionally, the first layer is made of a metal material.

In some embodiments, the second layer B includes the crossing-over portion 16 and the plurality of first touch electrodes. Optionally, the second layer B is made of a non-metal transparent electrode material. Examples of non-metal transparent electrode materials include, but are not limited to, transparent conductive metal oxides, graphene, carbon nanotubes, and the like. Optionally, the second layer B is made of indium tin oxide.

By having a first layer including the non-crossing-over portion, the first touch electrode signal lines, the second touch electrode signal lines, and the second ground line, and a second layer including the crossing-over portion and the plurality of first touch electrodes, the fabricating process can be simplified.

Referring to FIG. 7, the touch substrate in some embodiments further includes an insulating layer OC1 between the first layer A and the second layer B, a first via 17 and a second via 18 extending through the insulating layer OC1. The non-crossing-over portion 15 is electrically connected to the crossing-over portion 16 through the first via 17 and the second via 18, respectively.

The total number of the plurality of first touch electrode signal lines is the same as the total number of the plurality of first touch electrodes. The total number of the plurality of second touch electrode signal lines is the same as the total number of the plurality of second touch electrodes. In some embodiments, a total number of the plurality of second touch electrode signal lines is greater than a total number of the plurality of first touch electrode signal lines. For example, in some embodiments, the plurality of first touch electrode signal lines are a plurality of touch sensing signal lines, the plurality of second touch electrode signal lines are a plurality of touch driving signal lines, and the total number of touch driving signal lines is greater than the total number of touch sensing signal lines. Optionally, the total number of touch driving signal lines is 1.5 times of the total number of touch sensing signal lines. Optionally, the total number of touch driving signal lines is twice of the total number of touch sensing signal lines.

FIG. 8 illustrates discharge of electrostatic charge in a black matrix layer in a touch substrate in some embodiments according to the present disclosure. Referring to FIG. 8, due to the ground line in close proximity to the overlapping region, electrostatic charges in the overlapping region do not accumulate in the touch substrate. Instead, the electrostatic charges are timely diverted to ground by the ground line disposed around this region, preventing electrostatic breakdown of the black matrix layer BM. Product defects due to electrostatic discharge in the touch substrate can be reduced.

In another aspect, the present disclosure provides a method of fabricating a touch substrate having a touch electrode area and a peripheral area. In some embodiments, the method includes forming a first touch electrode layer on the base substrate having a plurality of first touch electrodes in the touch electrode area; forming a plurality of first touch electrode signal lines in the peripheral area coupled to the plurality of first touch electrodes respectively; and forming a first ground line in the peripheral area provided with a ground voltage, configured to discharge electrostatic charge in the touch substrate. In the present method, the first ground line is formed so that a projection of the first ground line on the base substrate overlaps with those of the plurality of first touch electrode signal lines, the first ground line being insulated from the plurality of first touch electrode signal lines. Optionally, the first ground line is formed so that it crosses over the plurality of first touch electrode signal lines.

In some embodiments, at least one (e.g., at least some, at least multiple ones, or all) of the plurality of first touch electrode signal lines are formed to include a first portion, a second portion, and a third portion connecting the first portion and the second portion; the first portion being configured to be connected to a touch control integrated circuit; the second portion being configured to be connected to a first touch electrode. The first portion is formed to extend substantially along a first direction. The third portion is formed to extend substantially along a second direction. The plurality of first touch electrodes are formed along the second direction. A portion of the first ground line is formed on a side of the third portion proximal to the plurality of first touch electrodes, crossing over the second portion, and extending substantially along the second direction.

In some embodiments, the step of forming the first ground line includes forming a single line encircling first portions and third portions of the at least one (e.g., at least some, at least multiple ones, or all) of the plurality of first touch electrode signal lines and crossing over second portions of the at least one (e.g., at least some, at least multiple ones, or all) of the plurality of first touch electrode signal lines. The area encircled by the first ground line is in the peripheral area and outside the touch electrode area.

In some embodiments, the step of forming the first ground line includes forming a first layer including a non-crossing-over portion of the first ground line; and forming a second layer including a crossing-over portion of the first ground line; the second layer being different from the first layer. Optionally, the non-crossing-over portion is formed so that a projection of the non-crossing-over portion on the base substrate is outside that of any first touch electrode signal line. Optionally, the crossing-over portion is formed so that a projection of the crossing-over portion on the base substrate overlaps with that of a first touch electrode signal line.

In some embodiments, the method includes forming the first layer including the non-crossing-over portion and the plurality of first touch electrode signal lines on the base substrate; forming an insulating layer on a side of the first layer distal to the base substrate; forming a first via and a second via extending through the insulating layer; and forming the second layer including the crossing-over portion and the plurality of first touch electrodes on a side of the insulating layer distal to the first layer. Optionally, the non-crossing-over portion electrically connected to two ends of the crossing-over portion through the first via and the second via, respectively.

In some embodiments, the step of forming the first layer includes forming a first layer including the non-crossing-over portion, the plurality of first touch electrode signal lines, a plurality of second touch electrode signal lines, and a second ground line in the peripheral area; the step of forming the second layer includes forming the second layer including the crossing-over portion in the peripheral area, and the plurality of first touch electrodes and a plurality of second touch electrodes in the touch electrode area. Optionally, the plurality of second touch electrode signal lines in the peripheral area coupled to the plurality of second touch electrodes respectively, and the second ground line encircles the touch electrode area.

In some embodiments, the method further includes forming a black matrix layer on the base substrate in a black matrix area prior to forming the first layer, the first layer is formed on a side of the black matrix layer distal to the base substrate. Optionally, the black matrix area is formed to partially overlap with the touch electrode area, forming an overlapping area. At least a portion of the first ground line is formed proximal to the overlapping area. The first ground line is formed to cross over the second portions of the at least one (e.g., at least some, at least multiple ones, or all) of the plurality of first touch electrode signal lines in proximity to the overlapping area.

Optionally, the plurality of first touch electrodes are a plurality of touch sensing electrodes, the plurality of first touch electrode signal lines are a plurality of touch sensing signal lines, the plurality of second touch electrodes are a plurality of touch driving electrodes, and the plurality of second touch electrode signal lines are a plurality of touch driving signal lines. Optionally, the plurality of first touch electrodes are a plurality of touch driving electrodes, the plurality of first touch electrode signal lines are a plurality of touch driving signal lines, the plurality of second touch electrodes are a plurality of touch sensing electrodes, and the plurality of second touch electrode signal lines are a plurality of touch sensing signal lines.

In another aspect, the present disclosure provides a touch display panel having a touch substrate described herein or fabricated by a method described herein.

In another aspect, the present disclosure provides a touch display apparatus having a touch display panel described herein. Examples of appropriate touch display apparatuses include, but are not limited to, an electronic paper, a mobile phone, a tablet computer, a television, a monitor, a notebook computer, a digital album, a gaming system, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A touch substrate having a touch electrode area and a peripheral area, comprising:
a base substrate;
a first touch electrode layer on the base substrate comprising a plurality of first touch electrodes in the touch electrode area;
a plurality of first touch electrode signal lines in the peripheral area coupled to the plurality of first touch electrodes respectively; and
a first ground line in the peripheral area provided with a ground voltage, configured to discharge electrostatic charge in the touch substrate;
wherein a projection of the first ground line on the base substrate overlaps with those of the plurality of first touch electrode signal lines;
the first ground line is insulated from the plurality of first touch electrode signal lines.

2. The touch substrate of claim 1, wherein the first ground line crosses over the plurality of first touch electrode signal lines.

3. The touch substrate of claim 1, wherein
at least one of the plurality of first touch electrode signal lines comprise a first portion, a second portion, and a third portion connecting the first portion and the second portion; the first portion being configured to be connected to a touch control integrated circuit; the second portion being configured to be connected to a first touch electrode;
the first portion extends substantially along a first direction;
the third portion extends substantially along a second direction;
the plurality of first touch electrodes are arranged along the second direction; and
a portion of the first ground line is on a side of the third portion proximal to the plurality of first touch electrodes and crosses over the second portion; the portion of the first ground line extending substantially along the second direction.

4. The touch substrate of claim 3, wherein the first ground line is a single line encircling first portions and third portions of the at least one of the plurality of first touch electrode signal lines and crossing over second portions of the at least one of the plurality of first touch electrode signal lines;
an area encircled by the first ground line is in the peripheral area and outside the touch electrode area.

5. The touch substrate of claim 1, wherein the first ground line comprises a non-crossing-over portion in a first layer and a crossing-over portion in a second layer different from the first layer,
a projection of the crossing-over portion on the base substrate overlaps with that of one of the plurality of first touch electrode signal lines; and
a projection of the non-crossing-over portion on the base substrate is outside that of any first touch electrode signal line.

6. The touch substrate of claim 5, wherein the first layer comprises the non-crossing-over portion of the first ground line and the plurality of first touch electrode signal lines.

7. The touch substrate of claim 5, wherein the second layer comprises the crossing-over portion of the first ground line and the plurality of first touch electrodes.

8. The touch substrate of claim 5, wherein the non-crossing-over portion of the first ground line is made of a metal material, and the crossing-over portion is made of a non-metal transparent electrode material.

9. The touch substrate of claim 5, wherein the first layer comprises the non-crossing-over portion and the plurality of first touch electrode signal lines;
the first layer is made of a metal material;
the second layer comprises the crossing-over portion and the plurality of first touch electrodes; and
the second layer is made of a non-metal transparent electrode material.

10. The touch substrate of claim 5, further comprising:
an insulating layer between the first layer and the second layer;
a first via and a second via extending through the insulating layer;
the non-crossing-over portion electrically connected to two ends of the crossing-over portion through the first via and the second via, respectively.

11. (canceled)

12. The touch substrate of claim 1, further comprising a second touch electrode layer on the base substrate comprising a plurality of second touch electrodes in the touch electrode area;
a plurality of second touch electrode signal lines in the peripheral area coupled to the plurality of second touch electrodes respectively; and
a second ground line in the peripheral area provided with a ground voltage, configured to discharge electrostatic charge in the touch substrate;
wherein the second ground line encircles the touch electrode area and the peripheral area.

13. The touch substrate of claim 12, wherein the plurality of first touch electrodes are a plurality of touch sensing electrodes, the plurality of first touch electrode signal lines are a plurality of touch sensing signal lines; and
the plurality of second touch electrodes are a plurality of touch driving electrodes, the plurality of second touch electrode signal lines are a plurality of touch driving signal lines.

14. The touch substrate of claim 12, wherein a total number of the plurality of second touch electrode signal lines is greater than a total number of the plurality of first touch electrode signal lines.

15. The touch substrate of claim 12, wherein the plurality of first touch electrode signal lines, the plurality of second touch electrode signal lines, and the second ground line are in a same layer.

16. The touch substrate of claim 12, wherein the plurality of first touch electrode signal lines, the plurality of second touch electrode signal lines, and the second ground line are made of a metal material.

17. A touch display apparatus, comprising a touch substrate of claim 1.

18. A method of fabricating a touch substrate having a touch electrode area and a peripheral area, comprising:
forming a first touch electrode layer on the base substrate comprising a plurality of first touch electrodes in the touch electrode area;
forming a plurality of first touch electrode signal lines in the peripheral area coupled to the plurality of first touch electrodes respectively; and
forming a first ground line in the peripheral area provided with a ground voltage, configured to discharge electrostatic charge in the touch substrate;
wherein the first ground line is formed so that a projection of the first ground line on the base substrate overlaps with those of the plurality of first touch electrode signal lines;
the first ground line is insulated from the plurality of first touch electrode signal lines.

19. The method of claim 18, wherein forming the first ground line comprises:
forming a first layer comprising a non-crossing-over portion of the first ground line; and
forming a second layer comprising a crossing-over portion of the first ground line; the second layer being different from the first layer;
wherein the non-crossing-over portion is formed so that a projection of the non-crossing-over portion on the base substrate is outside that of any first touch electrode signal line; and
the crossing-over portion is formed so that a projection of the crossing-over portion on the base substrate overlaps with that of a first touch electrode signal line.

20. The method of claim 18, comprising:
forming the first layer comprising the non-crossing-over portion and the plurality of first touch electrode signal lines on the base substrate;
forming an insulating layer on a side of the first layer distal to the base substrate;
forming a first via and a second via extending through the insulating layer; and
forming the second layer comprising the crossing-over portion and the plurality of first touch electrodes on a side of the insulating layer distal to the first layer;
wherein the non-crossing-over portion electrically connected to two ends of the crossing-over portion through the first via and the second via, respectively.

21. The method of claim 18, wherein forming the first layer comprises forming the first layer comprising the non-crossing-over portion, the plurality of first touch electrode signal lines, a plurality of second touch electrode signal lines, and a second ground line in the peripheral area;
forming the second layer comprises forming the second layer comprising the crossing-over portion in the peripheral area, and the plurality of first touch electrodes and a plurality of second touch electrodes in the touch electrode area;
the plurality of second touch electrode signal lines in the peripheral area coupled to the plurality of second touch electrodes respectively; and
the second ground line encircles the touch electrode area.
